(19) United States
(12) Patent Application Publication
(10) Pub. No.: US 2006/0029115 A1
(43) Pub. Date: Feb. 9, 2006

(54) Optical head with heat sink

(75) Inventors: Hee-sung Park, Suwon-si (KR); Chong-sam Chung, Hwaseong-si (KR); Kwang Kim, Suwon-si (KR); Jin-won Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/197,347

(22) Filed: Aug. 5, 2005

(30) Foreign Application Priority Data
Aug. 5, 2004 (KR) 2004-61795

(51) Int. Cl. H01S 3/04

(52) U.S. Cl. 372/36; 372/34

(57) ABSTRACT

An optical head with a heat sink. The optical head includes an optical bench; a laser diode combined with the optical bench; a first heat sink combined with a lower surface of the optical bench; and a second heat sink combined with an upper surface of the optical bench. A heat-dissipation structure of the laser diode with high output may be improved.

### CROSS-REFERENCE TO RELATED APPLICATIONS

This application claims the benefit of Korean Application No. 2004-61795, filed on Aug. 5, 2004, in the Korean Intellectual Property Office, the disclosure of which is incorporated herein by reference.

### BACKGROUND OF THE INVENTION

1. Field of the Invention

An aspect of the present invention relates to an optical head with a heat sink which effectively lowers the temperature of an active layer in which heat generated in a laser diode is dissipated.

2. Description of the Related Art

A conventional optical head with a heat sink is disclosed in U.S. Pat. No. 5,680,385. Referring to FIG. 1, in the conventional optical head, a laser diode 1 is fixed on a heat sink 3. The heat sink 3 is fixed on an optical bench 2 to dissipate heat that is generated in the laser diode 1. A photodiode 2a is formed on the optical bench 2.

A mirror 3a, which reflects a laser beam, is formed on one side of the heat sink 3 and is made of a material that has a similar thermal expansion coefficient to that of the laser diode 1. Further, the material should have good thermal conductivity.

Light emitted from the laser diode 1 is reflected by the mirror 3a and is then incident on a disc (not shown) through a holographic optical element 9 and a lens 10.

Since the amount of a dissipation of heat that is generated in the laser diode 1 is large, temperature rises relatively greatly depending on an amount of the use of the laser diode 1. In fact, as temperature rises, light output of the laser diode 1 is lowered, and the life span of the laser diode is reduced. Further, since a blue laser diode with a high output has been recently used, a problem caused by dissipation of heat generated in the laser diode becomes larger.

In the conventional optical head with the heat sink, the heat sink 3 is provided under the laser diode 1 and emits heat dissipated from the laser diode 1. However, since the heat sink 3 is provided on only a lower surface of the laser diode 1 in this structure, dissipating heat that is generated on the other surfaces of the laser diode is insufficient. In other words, as an optical drive becomes smaller and a recording density of a disc increases, output of a laser diode and the amount of a dissipation of heat that is generated in the laser diode increase. However, when the heat sink is provided on only one surface of the laser diode, dissipation of heat generated in the laser diode is insufficiently performed. Accordingly, the temperature of the laser diode rises relatively greatly such that this dissipation structure is inappropriate to be used with a recording apparatus with high output.

### SUMMARY OF THE INVENTION

An aspect of the present invention provides an optical head with a heat sink which effectively dissipates heat generated in a laser diode with high output.

According to an aspect of the present invention, there is provided an optical head, the optical head including: an optical bench; a laser diode combined with the optical bench; a first heat sink combined with a lower surface of the optical bench; and a second heat sink combined with an upper surface of the optical bench. A groove on which the laser diode is to be mounted may be formed in the optical bench and a reflecting surface on which light emitted from the laser diode is reflected may be formed on one side of the groove. The optical head may further include a third heat sink, a heat pipe, or a thermoelectric element connecting the first heat sink and the second heat sink to each other.

Additional and/or other aspects and advantages of the invention will be set forth in part in the description which follows and, in part, will be obvious from the description, or may be learned by practice of the invention.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee. These and/or other aspects and advantages of the invention will become apparent and more readily appreciated from the following description of the embodiments, taken in conjunction with the accompanying drawings of which:

FIG. 1 is a perspective view of a conventional optical head with a heat sink disclosed in U.S. Pat. No. 5,680,385;

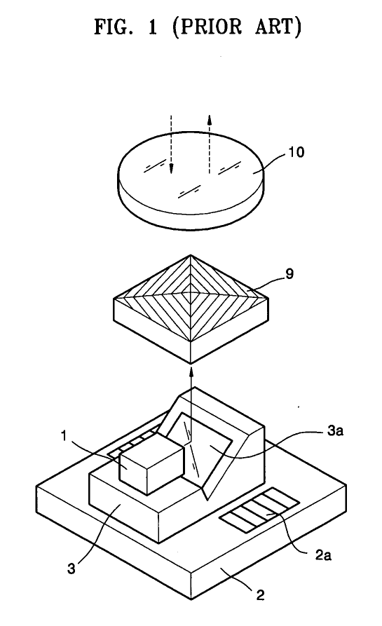

FIG. 2 is an exploded perspective view of an optical head with a heat sink according to an embodiment of the present invention;

FIG. 3A shows the distribution of temperature of a laser diode chip of the conventional optical head; and

FIG. 3B shows the distribution of temperature of a laser diode chip of the optical head according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

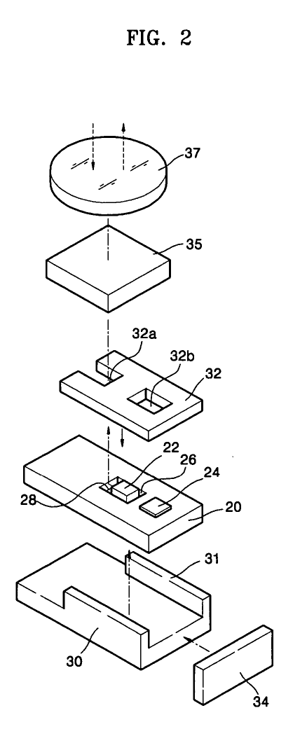

In an optical head, as shown in FIG. 2, according to an embodiment of the present invention, a laser diode 22 and a photodiode 24 are formed on an optical bench 20, a first heat sink 30 is provided under the optical bench 20, and a second heat sink 32 is provided on the laser diode 22. The first and second heat sinks 30 and 32 are made of copper with high thermal conductivity or a tungsten-based metallic material.

A groove 26 on which the laser diode 22 is to be mounted, is formed in the optical bench 20. The groove 26 has a reflecting surface 28 on which light emitted from the laser diode 22 is reflected. The second heat sink 32 comprises a first hole 32a formed so that light passes through a path on which light that is reflected on the reflecting surface 28 proceeds, and a second hole 32b formed on a path of light that is incident on the photodiode 24.

In addition, the optical head comprises a diffraction optical element 35 which diffracts light emitted from the laser diode 22 to divide the diffracted light into three beams, and an objective lens 37 which focuses light that has passed through the diffraction optical element 35 on a disc (not shown).

The first heat sink 30 may have a sidewall 31 to protect the optical bench 20. The optical bench 20 may be inserted between the first and second heat sinks 30 and 32 and simply assembled in a small size.

Further, a third heat sink 34 may be further provided on the sidewall 31 of the optical bench 20. A heat pipe or thermoelectric element instead of the third heat sink 34 may be provided.

Temperature characteristics caused by dissipation of heat generated in the optical head directly have relation with the life span of the laser diode. The life span of the laser diode may be mapped as an exponential function to illustrate that a length of the life span of the laser diode is inversely proportional to the temperature of an active layer in the laser diode. For example, whenever the temperature of the active layer rises by 10° C., the life span of the laser diode is reduced by 1/10. In particular, in case of the optical head applied to an optical drive, a recording density increases by using a celadon green laser diode with high output so that the optical head is used for a mobile. In addition, since a chip with high output is used in a laser diode used for communications, an improved structure of a heat sink for dissipating heat generated in the laser diode is more needed.

Heat that is generated in the laser diode 22 is absorbed into the first heat sink 30 through the optical bench 20. Simultaneously, heat generated in an upper portion of the laser diode is absorbed into the second heat sink 32. In particular, since the second heat sink 32 directly reduces the temperature of the active layer in which heat generated in the laser diode is dissipated concentratively, the second heat sink 32 contributes to improved performance of the optical head and extends the lifespan of the laser diode.

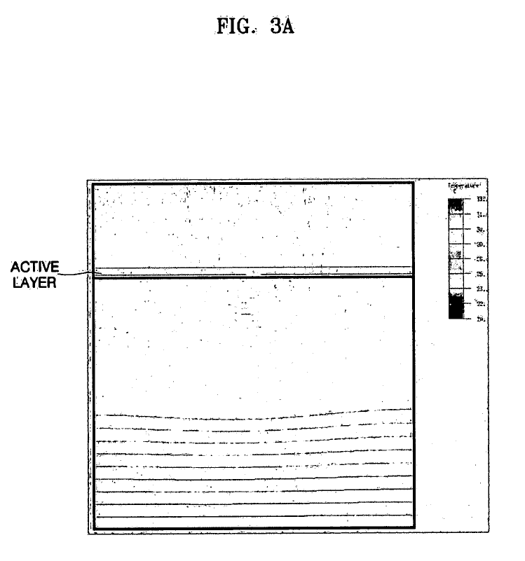

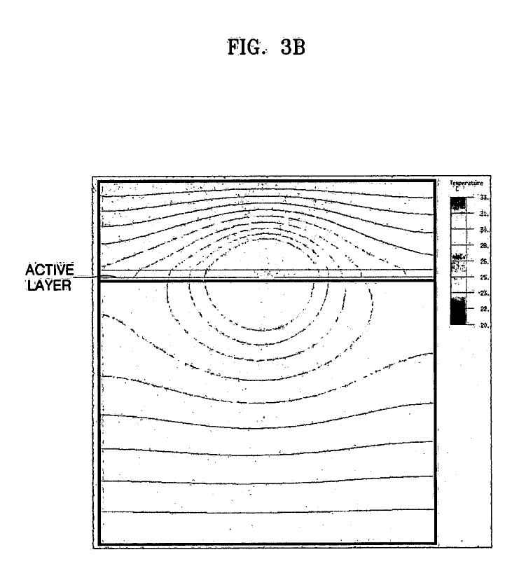

FIG. 3A shows the distribution of temperature of a laser diode when a heat sink is provided on only a lower surface of the laser diode of a conventional optical bench, and FIG. 3B shows the distribution of temperature of a laser diode when a heat sink is provided on each of lower and upper surfaces of the laser diode of the optical head according to the present invention. Referring to FIGS. 3A and 3B, in FIG. 3B, the temperature of the laser diode is overall lower than in FIG. 3A.

Further, heat that is absorbed into the first and second heat sinks 30 and 32 is dissipated to the third heat sink 34 so that the temperature of the laser diode may be more effectively reduced. By combining a heat pipe or thermoelectric element with the third heat sink 34 or by providing the heat pipe or thermoelectric element instead of the third heat sink 34, a better thermal transfer path may be provided.

As is described above, in the optical head according to an aspect of the present invention, the heat sink is provided on both upper and lower surfaces of the laser diode such that heat generated in the laser diode is effectively dissipated. Heat generated in the laser diode is dissipated such that the temperature of the laser diode is lowered. As such, the life span of the laser diode may be lengthened and further, the performance of the laser diode may be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical head comprising:
an optical bench;
a laser diode combined with the optical bench;
a first heat sink combined with a lower surface of the optical bench; and
a second heat sink combined with an upper surface of the optical bench.

2. The optical head of claim 1, wherein a groove on which the laser diode is to be mounted is formed in the optical bench and a reflecting surface on which light emitted from the laser diode is reflected is formed on one side of the groove.

3. The optical head of claim 2, wherein the second heat sink has a first hole through which light reflected on the reflecting surface passes.

4. The optical head of claim 3, further comprising a photodiode combined with the optical bench, wherein the second heat sink has a second hole through which light, incident on the photodiode, passes.

5. The optical head of claim 3, further comprising a third heat sink, a heat pipe, and/or a thermoelectric element connecting the first heat sink and the second heat sink to each other.

6. The optical head of claim 1, wherein the second heat sink has a first hole through which light reflected on the reflecting surface passes.

7. The optical head of claim 6, further comprising a photodiode combined with the optical bench, wherein the second heat sink has a second hole through which light, incident on the photodiode, passes.

8. The optical head of claim 6, further comprising a third heat sink, a heat pipe, and/or a thermoelectric element connecting the first heat sink and the second heat sink to each other.

9. An optical head, comprising:
an optical bench including a groove and a seating area, the groove have an angled reflecting surface;
a laser diode and a photodiode formed in the groove and on the seating area of the optical bench, respectively, such that the reflecting surface reflects light emitted from the laser diode;
a first heat sink provided under the optical bench so as to absorb heat from the optical bench; and
a second heat sink, provided opposite the first heat sink relative to the optical bench so as to absorb heat from the optical bench, the second heat sink defining a first hole through which light from the reflecting surface passes and a second hole through which light, incident on the photodiode, passes.

10. The optical head according to claim 9, wherein the first and second heat sinks are made of copper with a high thermal conductivity and/or a tungsten-based metallic material.

11. The optical head according to claim 9, further comprising:
a diffraction optical element to diffract light that is emitted from the laser diode; and
an objective lens to focus light that has passed through the diffraction optical element.

12. The optical head according to claim 9, wherein the first heat sink comprises a sidewall to protect the optical bench.

13. The optical head according to claim 12, further comprising a third heat sink provided on the sidewall.

14. The optical head according to claim 12, further comprising a heat pipe and/or a thermoelectric element provided on the sidewall.

15. The optical head according to claim 9, wherein heat that is generated in the laser diode is absorbed into the first heat sink through the optical bench.

16. The optical head according to claim 9, wherein heat that is generated in an upper portion of the laser diode is absorbed into the second heat sink.

17. The optical bench according to claim 13, wherein heat absorbed into the first and second heat sinks is dissipated to the third heat sink.

18. An optical head, comprising:
an optical bench including a groove and a seating area, the groove have an angled reflecting surface;
a laser diode and a photodiode formed in the groove and on the seating area of the optical bench, respectively, such that the reflecting surface reflects light emitted from the laser diode;
a first heat sink to absorb heat from the optical bench; and
a second heat sink to absorb heat from the optical bench, the second heat sink defining a first hole through which light from the reflecting surface passes and a second hole through which light, incident on the photodiode, passes.

19. The optical head according to claim 18, wherein the first and second heat sinks are located on opposite sides of the optical bench.

20. The optical head according to claim 19, wherein the first heat sink includes a sidewall on which a third heat sink is provided.
